(19) United States
(12) Patent Application Publication
(10) Pub. No.: US 2013/0089283 A1
(43) Pub. Date: Apr. 11, 2013

(54) ROLLING BEARING

(71) Applicants: Werner Trojahn, Niederwerrn (DE); Walter Holweger, Ependorf (DE); Silke Rösch, Niederwerrn (DE)

(72) Inventors: Werner Trojahn, Niederwerrn (DE); Walter Holweger, Ependorf (DE); Silke Rösch, Niederwerrn (DE)

(73) Assignee: SCHAEFFLER TECHNOLOGIES AG & CO. KG, Herzogenaurach (DE)

(21) Appl. No.: 13/433,391

(22) Filed: Mar. 29, 2012

(30) Foreign Application Priority Data
Mar. 29, 2011 (DE) 102011006296.3

(51) Int. Cl. F16C 33/34; F16C 33/62

(52) U.S. Cl. CPC F16C 33/34; F16C 33/62
USPC 384/445

(57) ABSTRACT

A rolling bearing having an outer ring, an inner ring and rolling bodies which roll on raceways of the rings. The raceway of the inner and/or outer ring and/or the surface of the rolling bodies has a burnishing layer, and the inner and/or the outer ring and/or the rolling bodies are formed of a steel which has a hardness of at least 58 HRC at least below the burnishing layer and which, at least below the burnishing layer, has: a nitrogen content at least in the marginal layer of 0.03-0.8%, the nitrogen being at least partially dissolved, a carbon content at least in the marginal layer of 0.1-1.2%, a nickel content of ≦0.4%, a silicon content of 0.2-1.0%, a chromium content of ≧1.0%, a sulfur content of ≦0.008%, an oxygen content of ≦15 ppm, and a titanium content of ≦50 ppm.

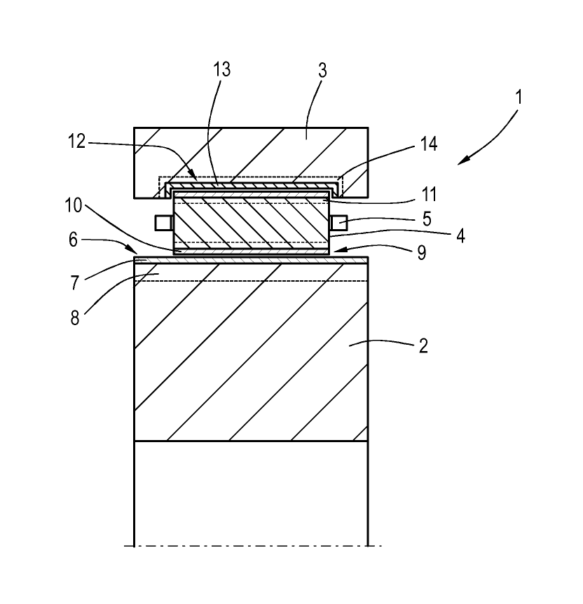

### CROSS-REFERENCE TO RELATED APPLICATIONS

This application claims the benefit of German Patent Application No. 102011006296.3, filed Mar. 29, 2011, which is incorporated herein by reference as if fully set forth.

### FIELD OF THE INVENTION

The invention relates to a rolling bearing comprising an outer ring, an inner ring and rolling bodies which roll on raceways of the rings.

### BACKGROUND

In addition to the Hertzian stress which results from the actual rolling operation, rolling bearings are often also exposed to further loads, for example a superposed oscillating load from vibrations, or high temperatures or changes in temperature, e.g. resulting from friction or a fluctuating ambient temperature, or electric fields, for example resulting from the operation of a frequency converter. Examples of typical uses are transmission bearings in wind power generators or in screw-type compressors or the like. Compared with the average service life for which a rolling bearing is designed, in such cases a significantly earlier bearing failure can often be observed, even though the Hertzian surface stress lies quite considerably below the fatigue strength. These instances of failure are characterized by the formation of cracks, which is known as pitting formation, below the surface, with these cracks arising already well below the maximum of the equivalent stress. The cracks propagate like a band in the material below the surface, and usually turn toward the surface. Since these bands, as they have not been etched, stand out considerably in an etched metallographic microsection when such components undergo material tests, they are referred to as “white bands” or as “white etching cracks” or, in the preliminary stage of a large crack, as “white etching area”. These cracks often arise even earlier if the marginal layer of the rolling bearing component is exposed to hydrogen. The latter is released, for example, from the lubricant with which the bearing is lubricated and which often consists of hydrocarbons, when the lubricant is subjected to loading between the bearing rings and the rolling bodies in the roll nip. The failure of the bearing can usually be attributed to these cracks, since investigations have shown that the conventional signs of fatigue, such as a changed residual stress or a decrease in the material strength, do not arise in the marginal layer.

DE 10 2007 055 575 A1 discloses a rolling bearing, or a raceway element, wherein, in order to achieve a long service life of the rolling bearing, in particular in view of the problems relating to pitting formation mentioned in the introduction, it is provided that this raceway element has residual compressive stresses amounting to at least approximately 400 MPa in an entire depth range of 0-about 40 μm below the surface of the raceway. This embodiment is based on the understanding that the crack formation or the crack growth can be counteracted by a suitable residual compressive stress in the marginal layer of the material, resulting in an increase in service life. These increased residual compressive stresses are produced mechanically, for example by hard turning or high-speed milling and also appropriate marginal layer hardening processes, such as hot oil blasting. This means that complex working steps or remachining steps are required.

### SUMMARY

The invention addresses this by providing a rolling bearing in the case of which the tendency toward crack formation is reduced in a simple manner.

Here, in the case of a rolling bearing of the type mentioned in the introduction, it is provided according to the invention that the raceway of the inner and/or outer ring and/or the surface of the rolling bodies has a burnishing layer, and that the inner and/or the outer ring and/or the rolling bodies are formed of a steel which has a hardness of at least 58 HRC at least below the burnishing layer and which, at least below the burnishing layer, has:
a nitrogen content at least in the marginal layer of 0.03-0.8%, the nitrogen being at least partially dissolved,
a carbon content at least in the marginal layer of 0.1-1.2%,
a nickel content of ≦0.4%,
a silicon content of 0.2-1.0%,
a chromium content of ≧1.0%,
a sulfur content of ≦0.008%,
an oxygen content of ≦15 ppm,
a titanium content of ≦50 ppm.

The invention provides for a reduction in the tendency of a bearing component toward the crack formation described in the introduction by the application of a burnishing layer and also by a selection of the element proportions in the steel used which is advantageous in this respect. This is based on the understanding that the stresses which are mentioned in the introduction, and are present in addition to the actual rolling stress, or the Hertzian stress, trigger certain processes which promote cracking in the steel. Thus, oscillations, electric fields and hydrogen acting on the marginal areas trigger dislocation formation and dislocation motion in the steel. Higher temperatures as well as a possible hydrogen content further increase the mobility, and therefore likewise promote dislocation. Furthermore, constituents such as oxides, sulfides, carbides or else other imperfections, at which dislocations form particularly readily as a result of an excessive local increase in stress, are generally always present in the steel. If the external factors described above act continuously, slip bands can form, and these eventually reach a critical size, leading to crack formation. The crack can readily propagate, which then leads to failure of the rolling bearing. To this end, stresses well below the normal, permanent bearable stress are sufficient.

This is counteracted in an advantageous manner by the measures provided according to the invention. The invention firstly provides for the raceway of one or both rings and/or the surface of the rolling bodies to be coated with a burnishing layer, which is applied for example in a two-bath burnishing process. The burnishing bath can consist, for example, of a burnishing salt containing NaOH and NaNO₂, with conventional bath temperatures lying between 135 and 145° C. In the course of the burnishing process, a burnishing layer is formed, which in most cases is present as a mixed layer (conversion layer) consisting of Fe₂O₃, Fe₃O₄ and FeOOH; if appropriate, it can also contain graphite precipitations. Said burnishing layer acts as a damping layer which reduces any stresses which are applied, since it has a hardness which is considerably less than the hardness of the marginal layer of the steel material used for the bearing component. Since the burnishing layer is made of the above-mentioned oxides, it also acts as an insulator against any electrical voltages applied to the rolling bearing. Furthermore, the burnishing layer reduces the friction between the rolling bodies and the respective bearing ring, and therefore as a result of this the bearing temperature is also reduced. Finally, it acts as a diffusion barrier for hydrogen which may form from the lubricant, if the latter is subjected to loading. This is because the burnishing layer prevents direct metallic contact between the raceways of the rings and the rolling bodies, such that any hydrogen which forms cannot diffuse directly into the steel base material, but instead is prevented from doing so by the burnishing layer.

If the burnishing layer becomes worn over the course of the service life of the bearing, the graphite precipitations which are preferably incorporated in the burnishing layer remain. They form a thin surface layer which at least also continues to reduce the friction between the rolling bodies and the rings. Due to the softness of the graphite layer which remains, vibration damping is also provided to a certain extent.

Below the burnishing layer, the steel base material is optimized in respect of the composition and the heat treatment thereof, so as to prevent the formation of local dislocation bands, which, as has been found, are the cause of the pitting formation.

Thus, firstly nitrogen and carbon are introduced at the marginal areas in a targeted manner by a carbonitriding process, the nitrogen content in the marginal layer being 0.03-0.8%. The nitrogen must be present in at least partially dissolved form. The carbon content of the marginal layer is between 0.1 and 1.2%. The carbonitriding sets the hardness of the marginal layer, which, as stated, is at least 58 HC.

Particularly in respect of the introduction of nitrogen, the nickel content is limited according to the invention to at most 0.4%. This is necessary in order to ensure that the nitrogen can penetrate to a sufficient depth during the carbonitriding so as to be active to the required depth. As stated, the nitrogen which has diffused in is dissolved to a certain extent, but at least to a content of 0.02%. The proportion of the dissolved nitrogen content is all the greater, the lower the nickel content. For this reason, the nickel content is limited according to the invention to at most 0.4%. This is because nickel reduces the solubility of nitrogen in the steel. On the contrary, chromium is advantageous for the solubility of the nitrogen, and therefore according to the invention the chromium content is at least 1.0%. In particular with regard to the corrosion resistance of the steel base material, it can be 13% and more. This means that the content of dissolved nitrogen is all the greater, the lower the nickel content and the greater the chromium content. Since dissolved nitrogen impedes the dislocation motion, it is necessary for a sufficient proportion of dissolved nitrogen to be present in the marginal layer and also to a sufficient material depth, in order to counteract the crack formation.

Silicon, which is present in an amount of at least 0.2% according to the invention, also counteracts the dislocation motion. However, silicon can also prevent the diffusion of nitrogen if it is present in an excessive quantity, and therefore the silicon content is limited according to the invention to at most 1.0%.

The nitrogen which has diffused in is not present in completely dissolved form, but rather only in partially dissolved form. The undissolved nitrogen is precipitated in the form of very hard iron nitrides in a very fine distribution. These fine precipitations, too, act as barriers for dislocations, such that a high dislocation density is prevented, i.e. therefore no dislocation bands can form.

The sulfur, oxygen and titanium contents are also limited. Sulfur which is present leads to the formation of iron sulfides, which can precipitate and act as cracking nuclei. Therefore, the sulfur content is limited according to the invention to at most 0.008%. Titanium which is present leads to the formation of titanium carbonitrides, which, since they form relatively sharp-edged precipitations, likewise act as cracking nuclei. The titanium content is therefore limited to at most 50 ppm. Finally, oxygen which is present can lead to the formation of iron oxides in the steel base material, and these are likewise present as precipitations and can represent cracking nuclei.

Overall, the invention consequently proposes a rolling bearing with bearing components which tend toward pitting or crack formation to a considerably reduced extent, as a result of the functional combination of the burnishing layer with a composition of the steel base material which inhibits the formation of dislocations.

Even though cracks are formed primarily in the region of the raceways of the bearing rings, and consequently the bearing rings in particular are formed according to the invention, the surface of the rolling bodies can of course optionally also be formed accordingly. This means that preferably both the bearing rings and the rolling bodies are formed according to the invention, but all the same it is also possible for only the bearing rings or only the rolling bodies to be formed accordingly, for example.

As already described, the nitrogen is dissolved to a certain proportion in the steel base material in the region of the marginal zone, the dissolved proportion being all the greater, the lower the nickel content and the greater the chromium content. The content of dissolved nitrogen should be at least 0.02%, preferably more, since, as stated, the dissolved nitrogen impedes the dislocation motion.

The burnishing layer itself should have a thickness of 1-20 μm, and the hardness thereof should be ≦300 HV. As already described, it should also preferably contain graphite precipitations.

### BRIEF DESCRIPTION OF THE DRAWING

The FIGURE shows, by way of example, a section view through a rolling bearing.

### DETAILED DESCRIPTION OF THE PREFERRED EMBODIMENTS

Referring to the FIGURE, a rolling bearing 1 according to the invention is shown. The rolling bearing includes an inner ring 2, an outer ring 3 and also rolling bodies 4, which are arranged between said rings and are held in a cage 5.

The inner ring 2 has an outer raceway 6, to which a burnishing layer 7 has been applied. A marginal zone 8, in which there is an increased nitrogen and carbon content as a result of a carbonitriding process, is formed below the burnishing layer 7. The nitrogen content is between 0.03 and 0.8%, with at least 0.02% being dissolved in the steel base material. The steel base material additionally has a very small nickel content of ≦0.4%, a silicon content of 0.2%-1.0%, a chromium content of ≧1.0%, a sulfur content of ≦0.008%, an oxygen content of ≦15 ppm, and a titanium content of ≦50 ppm.

Similarly, the surface 9 of the rolling bodies is also provided with a burnishing layer 10, the rolling bodies also have a marginal zone 11 having the same composition as the marginal zone 8, and also the steel base material of the rolling bodies 4 has the same composition as the steel base material of the inner ring 2.

This also applies with respect to the outer ring 3. The outer ring 3 also has a burnishing layer 13 in the region of the raceway 12 thereof, and furthermore provision is likewise made of a marginal zone 14 having an increased nitrogen and carbon content. The outer ring 3 also is formed of the described steel base material with the composition defined according to the invention.

Even though, in the exemplary embodiment described, both the inner ring 2 and also the outer ring 3 and the rolling bodies 4 have the burnishing layer, and are designed according to the invention both in terms of the marginal zone and in terms of the steel base material, it is already sufficient, for reducing the tendency toward crack formation in the rolling bearing components, if only the inner ring 2 and the outer ring 3 are configured in such a manner, and the rolling bodies 4 do not undergo any special treatment.

### LIST OF REFERENCE NUMERALS

1 Rolling bearing

2 Inner ring

3 Outer ring

4 Rolling bodies

5 Cage

6 Raceway

7 Burnishing layer

8 Marginal zone

9 Surface

10 Burnishing layer

11 Marginal zone

12 Raceway

13 Burnishing layer

14 Marginal zone

1. A rolling bearing comprising an outer ring, an inner ring and rolling bodies which roll on raceways of the rings, wherein the raceway of at least one of the inner, the outer ring or a surface of the rolling bodies has a burnishing layer, and the at least one of the inner ring, the outer ring or the rolling bodies are formed of a steel which has a hardness of at least 58 HRC at least below the burnishing layer and which, at least below the burnishing layer, has:
a nitrogen content at least in a marginal layer of 0.03-0.8%, the nitrogen being at least partially dissolved,
a carbon content at least in the marginal layer of 0.1-1.2%,
a nickel content of ≦0.4%,
a silicon content of 0.2-1.0%,
a chromium content of ≧1.0%,
a sulfur content of ≦0.008%,
an oxygen content of ≦15 ppm, and
a titanium content of ≦50 ppm.

2. The rolling bearing as claimed in claim 1, wherein the content of nitrogen dissolved in the steel is at least 0.02%.

3. The rolling bearing as claimed in claim 1, wherein the burnishing layer has a thickness of 1-20 μm.

4. The rolling bearing as claimed in claim 1, wherein the burnishing layer has a hardness of ≦300 HV.

5. The rolling bearing as claimed in claim 1, wherein the burnishing layer has graphite precipitations.
